(19) United States
(12) Patent Application Publication
(10) Pub. No.: US 2018/0095462 A1
(43) Pub. Date: Apr. 5, 2018

(54) Method for Determining Road Surface Based on Vehicle Data

(71) Applicant: Hyundai Motor Company, Seoul (KR)

(72) Inventors: Si Jun Kim, Seoul (KR); Hai Jin Seo, Yongin-si (KR)

(21) Appl. No.: 15/371,629

(22) Filed: Dec. 7, 2016

(30) Foreign Application Priority Data
Oct. 4, 2016 (KR) 10-2016-0127658

(51) Int. Cl. G05D 1/00; B60W 10/18; B60W 10/04; B60W 30/02; B60W 30/14; B60W 40/068; B60W 50/00; G06N 99/00

(52) U.S. Cl. CPC G05D 1/0088; B60W 10/18; B60W 10/04; B60W 30/02; B60W 2050/0018; B60W 40/068; B60W 50/0098; G06N 99/005; B60W 30/14

(57) ABSTRACT

There is provided a method for determining, by a controller, a road surface based on vehicle data, including: classifying driving conditions of a vehicle into a plurality of cases; applying a learning logic to each of the classified cases according to characteristics of the cases and constructing an inference model for each case; and determining whether a road surface on which the vehicle is running is a high friction road surface or a low friction road surface based on the inference model for each case.

### CROSS-REFERENCE TO RELATED APPLICATIONS

This application is based on and claims the benefit of priority to Korean Patent Application No. 10-2016-0127658, filed on Oct. 4, 2016, in the Korean Intellectual Property Office, the disclosure of which is incorporated herein in its entirety by reference.

### TECHNICAL FIELD

The present disclosure relates to a method for determining a road surface based on vehicle data.

### BACKGROUND

In order to secure the safety of drivers, vehicles have been equipped with various user-friendly systems, such as an anti-lock brake system (ABS), an electronic stability control (ESC) system, a smart cruise control (SCC) system, and an advanced driver assistance system (ADAS).

For optimum performance, these user-friendly systems may control movements of vehicles by taking road surface conditions into account. Here, the road surface conditions refer to a high friction road surface such as a dry asphalt road and a dry cement road and a low friction road surface such as a rainy road, a snowy road, and a dirt road.

Conventionally, there are a method for determining whether a road surface is a high friction road surface or a low friction road surface based on kinetic data such as wheel speed, engine torque, and vehicle speed, and a method for determining whether a road surface is a high friction road surface or a low friction road surface based on data from various sensors such as a road surface directivity ultrasonic sensor and a microphone.

First, the method for determining a road surface based on kinetic data determines whether the road surface is a high friction road surface or a low friction road surface on the basis of a vehicle slip phenomenon. Thus, when the vehicle is running on a road of specific pattern where there is no rapid acceleration or deceleration, it would be difficult to determine whether the road surface on which the vehicle is running is a high friction road surface or a low friction road surface.

Second, the method for determining a road surface based on data from a road surface directivity ultrasonic sensor requires the additional installation of the sensor, causing an increase in vehicle production costs.

### SUMMARY

The present disclosure relates to a method for determining a road surface based on vehicle data and, in particular embodiments, to a technology for determining whether a road surface on which a vehicle is running is a high friction road surface or a low friction road surface, based on vehicle data obtained from an in-vehicle network.

An in-vehicle network according to exemplary embodiments of the present disclosure includes Controller Area Network (CAN), Local Interconnect Network (LIN), FlexRay, and Media Oriented Systems Transport (MOST).

An aspect of the present disclosure provides a method for determining a road surface based on vehicle data by classifying driving conditions of a vehicle into predetermined cases, applying a learning logic to each case according to characteristics of the cases to construct an inference model for each case, and determining whether a road surface on which the vehicle is running is a high friction road surface or a low friction road surface based on the inference model for each case, thereby determining road surface conditions quickly and accurately regardless of types of roads.

The present inventive concept will be more clearly understood from exemplary embodiments of the present disclosure. In addition, it will be apparent that advantages of the present disclosure can be achieved by elements and features claimed in the claims and a combination thereof.

According to an aspect of the present disclosure, a method for determining, by a controller, a road surface based on vehicle data includes: classifying driving conditions of a vehicle into a plurality of cases; applying a learning logic to each of the classified cases according to characteristics of the cases and constructing an inference model for each case; and determining whether a road surface on which the vehicle is running is a high friction road surface or a low friction road surface based on the inference model for each case.

### BRIEF DESCRIPTION OF THE DRAWINGS

The above and other objects, features, and advantages of the present disclosure will be more apparent from the following detailed description taken in conjunction with the accompanying drawings:

FIG. 1 illustrates a block diagram of a process of constructing an inference model based on a relationship between an operator's operation of a vehicle and a movement of the vehicle resulting therefrom;

FIG. 2 illustrates a block diagram of the configuration of an input unit and a pre-processing unit, according to an exemplary embodiment of the present disclosure;

FIG. 3 illustrates a block diagram of the configuration of a time window buffer, according to an exemplary embodiment of the present disclosure;

FIG. 4 illustrates a block diagram of a process of determining a road surface based on an inference model for each case, according to an exemplary embodiment of the present disclosure;

FIG. 5 illustrates a block diagram of the function of a logic operation unit, according to an exemplary embodiment of the present disclosure; and

FIG. 6 illustrates a flowchart of a method for determining a road surface based on vehicle data, according to an exemplary embodiment of the present disclosure.

### DETAILED DESCRIPTION OF ILLUSTRATIVE EMBODIMENTS

The above and other objects, features, and advantages of the present disclosure will be more clearly understood from the following detailed description taken in conjunction with the accompanying drawings so that those skilled in the art to which the present disclosure pertains can easily carry out technical ideas described herein. In addition, a detailed description of well-known techniques associated with the present disclosure will be ruled out in order not to unnecessarily obscure the gist of the present disclosure. Hereinafter, exemplary embodiments of the present disclosure will be described in detail with reference to the accompanying drawings.

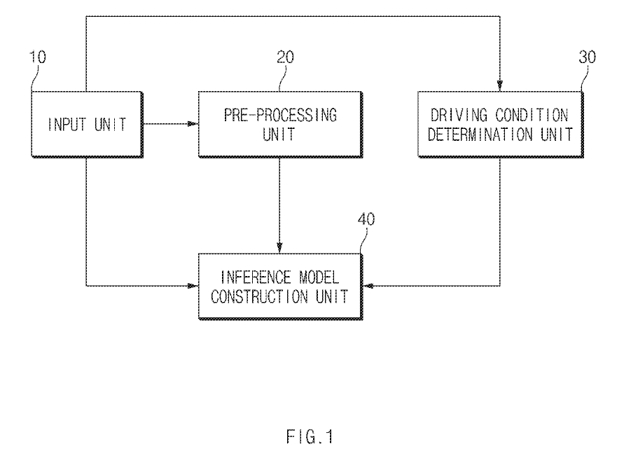

FIG. 1 illustrates a block diagram of a process of constructing an inference model based on a relationship between an operator's operation of a vehicle and a movement of the vehicle resulting therefrom, and also refers to a function block of a controller (processor) which performs the process.

As illustrated in FIG. 1, the controller for constructing an inference model, according to an exemplary embodiment of the present disclosure, includes an input unit 10, a pre-processing unit 20, a driving condition determination unit 30, and an inference model construction unit 40.

With respect to each of the aforementioned elements, first, the input unit 10 may receive data (hereinafter, also referred to as the “operator's operation data”) generated by the operator's operation of the vehicle and data (hereinafter, also referred to as the “vehicle movement data”) related to the movement of the vehicle resulting from the operator's operation. Here, the operator's operation refers to both a lateral operation of the vehicle and a longitudinal operation thereof, and includes the steering, acceleration, and deceleration of the vehicle. In addition, the movement of the vehicle includes a lateral movement and a longitudinal movement.

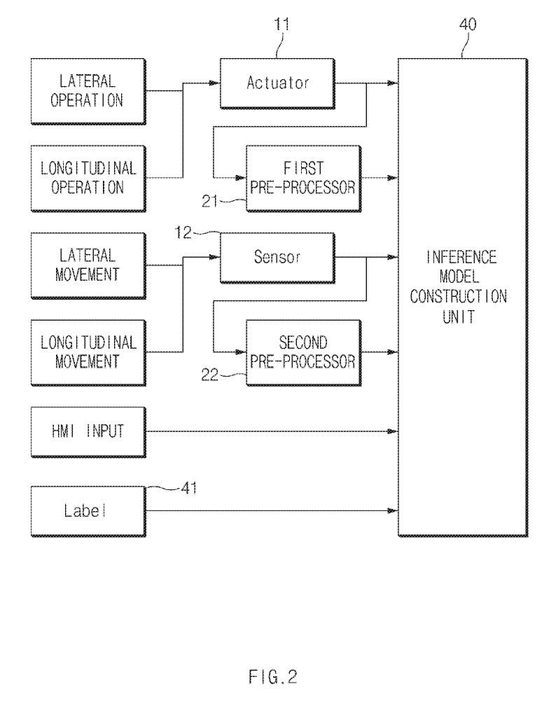

As illustrated in FIG. 2, the input unit 10 includes an actuator 11 detecting the operator's operation data and a sensor 12 detecting the vehicle movement data.

For example, the operator's operation data includes steering angle, longitudinal acceleration, and deceleration (brake), and the vehicle movement data includes longitudinal acceleration sensor (LAS) data, wheel speed sensor (WSS) data, accel pedal position sensor (APS) data, steering wheel angle sensor (SAS) data, yaw rate sensor (YRS) data, and speed data.

In addition, the input unit 10 further includes a user input device (HMI INPUT) to receive various information or commands from a user.

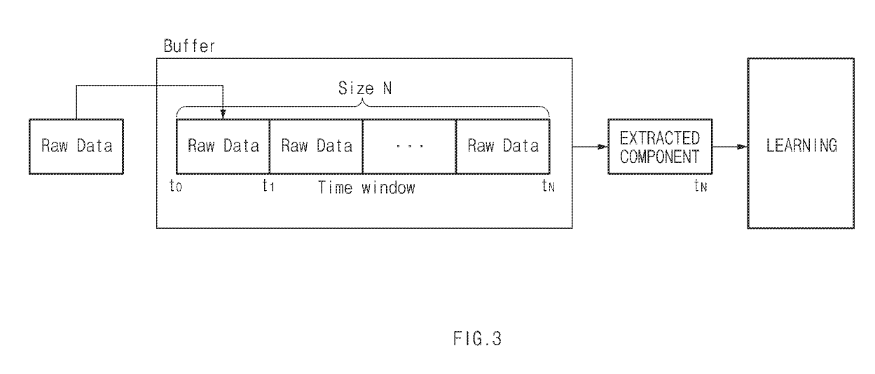

The pre-processing unit 20 may apply a time window buffer of a predetermined size as illustrated in FIG. 3 to the operator's operation data (Raw data) output from the actuator 11 and the vehicle movement data (Raw data) output from the sensor 12 to extract components of respective windows and calculate data characteristic values in a predetermined time interval. The calculated data values may be used for learning.

Here, the data characteristic values include an average value, a median value, a standard deviation, a differential value, an integral value, a correlation value, a fast Fourier transform (FFT) value, and a frequency conversion value. For example, the pre-processing unit 20 may calculate the variance of a difference between a front wheel speed and a rear wheel speed, wheel acceleration, the variance of the wheel acceleration, and the wheel speed average, on the basis of the time window.

The pre-processing unit 20 includes a first preprocessor 21 calculating the data characteristic values by applying the time window buffer of a predetermined size to the operator's operation data, and a second preprocessor 22 calculating the data characteristic values by applying the time window buffer of a predetermined size to the vehicle movement data.

Meanwhile, the pre-processing unit 20 may perform the following functions:

1) A standard deviation LAS_Std of 50 LAS data (values) may be calculated.

2) A standard deviation FR_Diff_Std may be calculated with respect to 50 values obtained by subtracting the average speed of the rear wheels from the average speed of the front wheels. In other words, after the calculation of subtracting the average speed of the rear wheels from the average speed of the front wheels may be made 50 times, the standard deviation of 50 result values may be calculated. Here, the front wheels include a front left wheel and a front right wheel, and the rear wheels include a rear left wheel and a rear right wheel.

3) A standard deviation LR_Diff_Std may be calculated with respect to 50 values obtained by subtracting the average speed of the left wheels from the average speed of the right wheels. Here, the right wheels include a front right wheel and a rear right wheel, and the left wheels include a front left wheel and a rear left wheel.

4) An average value APS_Avg of 50 APS data (values) may be calculated.

5) The sum APS_Diff of 50 differential values of APS data (50 result values obtained by subtracting a previous APS value from a current APS value) may be calculated.

6) The sum SAS_Diff of 50 differential values of SAS data (50 result values obtained by subtracting a previous SAS value from a current SAS value) may be calculated.

7) An average value SAS_Avg of 50 SAS data (values) may be calculated.

The driving condition determination unit 30 may determine driving conditions of the vehicle on the basis of the vehicle movement data. In other words, it may be determined whether a current driving condition of the vehicle is normal driving, acceleration driving, or deceleration driving, based on vehicle speed.

Hereinafter, the function of the driving condition determination unit 30 will be described with reference to table 1 below.

TABLE 1

| | Strong | Slight | Constant | Power | Slow | Rapid | Rapid |
|---|---|---|---|---|---|---|---|
| | Acceleration | Acceleration | Speed | Off | Braking | Braking | Acceleration |
| High | Case 1 | Case 2 | Case 3 | Case 4 | Case 9 | Case 10 | Case 11 |
| Speed | | | | | | | |
| Low | Case 5 | Case 6 | Case 7 | Case 8 | | | |
| Speed | | | | | | | |

In Table 1, “High Speed” refers to a case in which the speed of the vehicle exceeds 55 KPH, “Low Speed” refers to a case in which the speed of the vehicle is less than 55 KPH, “Strong Acceleration” refers to a case in which the speed of the vehicle is increased by 3 KPH per second, “Slight Acceleration” refers to a case in which the speed of the vehicle is increased by 1 KPH per second, “Constant Speed” refers to a case in which the speed of the vehicle is changed within a predetermined range (−0.5 to 0.5 KPH), “Power Off” refers to a case in which the speed of the vehicle is reduced by 0.5 KPH per second, “Slow Braking” refers to a case in which the gravitational acceleration exceeds −0.6 g, “Rapid Braking” refers to a case in which the gravitational acceleration is less than or equal to −0.6 g, and “Rapid Acceleration” refers to a case in which an APS data value is the maximum.

Therefore, case 1 represents the occurrence of strong acceleration in a state in which the vehicle is running at high speed, case 2 represents the occurrence of slight acceleration in a state in which the vehicle is running at high speed, case 3 represents the occurrence of constant speed in a state in which the vehicle is running at high speed, case 4 represents the occurrence of power-off in a state in which the vehicle is running at high speed, case 5 represents the occurrence of strong acceleration in a state in which the vehicle is running at low speed, case 6 represents the occurrence of slight acceleration in a state in which the vehicle is running at low speed, case 7 represents the occurrence of constant speed in a state in which the vehicle is running at low speed, case 8 represents the occurrence of power off in a state in which the vehicle is running at low speed, case 9 represents the occurrence of slow braking irrespective of a state in which the vehicle is running at high speed or low speed, case 10 represents the occurrence of rapid braking irrespective of a state in which the vehicle is running at high speed or low speed, and case 11 represents the occurrence of rapid acceleration irrespective of a state in which the vehicle is running at high speed or low speed.

Here, the normal driving conditions include case 2, case 3, case 6, and case 7, the acceleration driving conditions include case 1, case 5, and case 11, and the deceleration driving conditions include case 4, case 8, case 9, and case 10.

The inference model construction unit 40 may be a module for off-line learning, and may construct inference models using learning logics that correspond to the driving conditions determined by the driving condition determination unit 30.

In other words, the inference model construction unit 40 may learn the learning logics by applying a complex tree as the learning logic to the normal driving condition, applying a support vector machine (SVM) technique as the learning logic to the acceleration driving condition, and applying a supervised learning neural network technique as the learning logic to the deceleration driving condition. This is to apply the optimized learning logic to respective driving conditions.

For example, the inference model construction unit 40 may learn the learning logic of the complex tree using the lateral movement data (for example, a direction angle variation that is calculated using SAS data and YRS data) and the longitudinal movement data (for example, APS data, and the variance of a difference between the front wheel speed and the rear wheel speed).

In addition, the inference model construction unit 40 may calculate a high frequency energy in the variation of wheel speed average (through frequency conversion), and perform a 2D map matching with the wheel acceleration and the APS data.

In addition, the inference model construction unit 40 may learn the learning logic of the neural network technique using the vehicle speed, longitudinal acceleration, and the variance of the longitudinal acceleration.

Meanwhile, the inference model construction unit 40 may receive label information 41 informing whether data that is input for learning is a high friction road surface or a low friction road surface. The inference model construction unit 40 may generate the inference model of higher quality by performing the learning process several times on a plurality of high friction roads or a plurality of low friction roads.

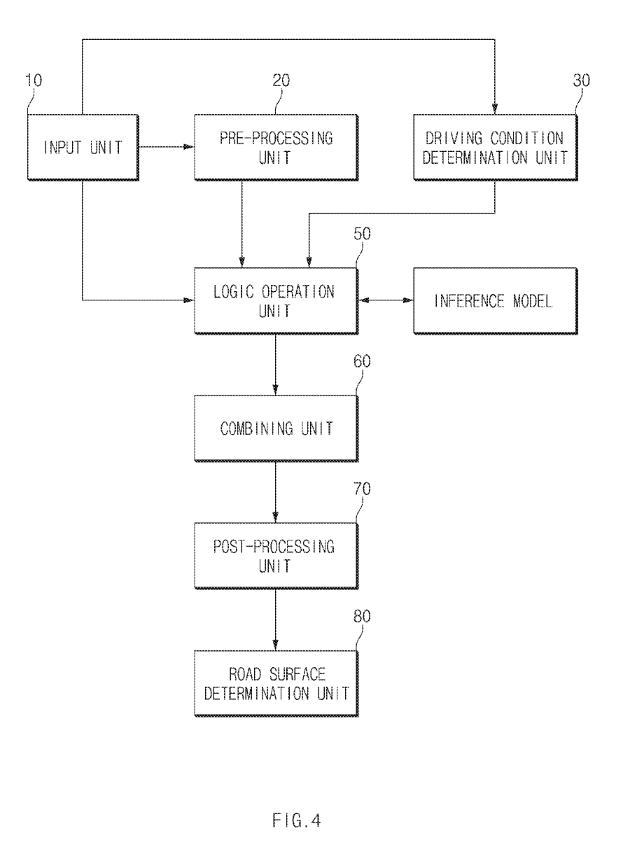

The inference model for each case may be applied to the vehicle and be used to determine the low friction road surface. Hereinafter, a process of determining a road surface based on an inference model for each case will be described with reference to FIG. 4.

FIG. 4 illustrates a block diagram of a process of determining a road surface based on an inference model for each case, and also refers to a function block of a controller (processor) which performs the process.

As illustrated in FIG. 4, the controller for determining a road surface based on an inference model for each case, according to an exemplary embodiment of the present disclosure, includes the input unit 10, the pre-processing unit 20, the driving condition determination unit 30, a logic operation unit 50, a combining unit 60, a post-processing unit 70, and a road surface determination unit 80.

Since the input unit 10, the pre-processing unit 20, and the driving condition determination unit 30 perform the same functions as those described in the process of constructing the inference model, the other elements will be described below.

The logic operation unit 50 may determine an inference model corresponding to a particular driving condition determined by the driving condition determination unit 30.

The logic operation unit 50 may extract data corresponding to the determined inference model from the data from the input unit 10 and the data from the pre-processing unit 20, input the extracted data to the inference model to obtain a result value. Here, the result value is between a value (for example, 0) representing a high friction road surface and a value (for example, 1) representing a low friction road surface.

In other words, the logic operation unit 50 may use a first inference model generated by applying the complex tree to a case corresponding to the normal driving condition, use a second inference model generated by applying the SVM technique to a case corresponding to the acceleration driving condition, and use a third inference model generated by applying the neural network technique to a case corresponding to the deceleration driving condition.

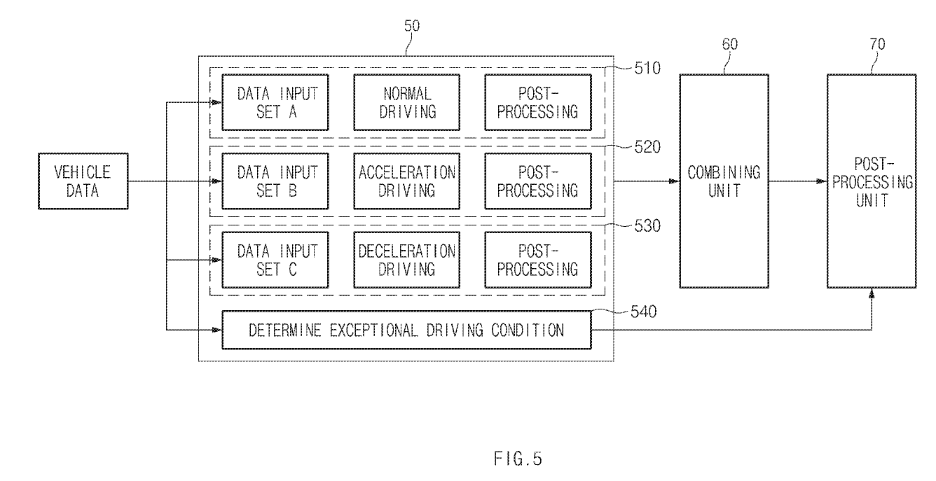

Referring to FIG. 5, the function of the logic operation unit 50 will be detailed.

“510” denotes a step of performing a primary post-processing (filtering) of data input set A corresponding to the first inference model when the driving condition is the normal driving condition, inputting the post-processed data to the first inference model to obtain a first result value.

“520” denotes a step of performing a secondary post-processing (filtering) of data input set B corresponding to the second inference model when the driving condition is the acceleration driving condition, inputting the post-processed data to the second inference model to obtain a second result value.

“530” denotes a step of performing a tertiary post-processing (filtering) of data input set C corresponding to the third inference model when the driving condition is the deceleration driving condition, inputting the post-processed data to the third inference model to obtain a third result value.

Here, the steps 510, 520, and 530 may be performed at the same time or at different times, or may be performed at overlapping times.

In addition, when the result value obtained based on the inference model is divergent, the logic operation unit 50 may determine the driving condition as an excessive driving condition (rough road driving) that is difficult to be determined by the learning logic, and notify this to the post-processing unit 70 in step 540.

Meanwhile, the driving condition of the vehicle is changing every moment. In other words, there is often a state transition among the aforementioned eleven cases.

Therefore, in order to determine a low friction road surface, it is necessary to combine the result values obtained by applying the inference models to the corresponding cases in the order of the occurrence of the cases. This may be performed by the combining unit 60.

For example, when the order of occurrence is case 1, case 3, case 5, and case 2, and the result values are 0.8 in case 1, 0.7 in case 3, 0.5 in case 5, and 0.7 in case 2, the values 0.8, 0.7, 0.5, and 0.7 may be connected in order of case 1, case 3, case 5, and case 2. If the result values are generated in a short time interval, the combined result is illustrated as a graph.

Here, the combining unit 60 may give a weighting based on a time for which a current case is maintained, thereby delaying a transition time to a next case. This may be configured to further include a determination buffer (not shown).

For example, when case 1 occurs instantaneously in a state in which case 3 is maintained for a predetermined time (case 1 is not maintained for a predetermined time), the combining unit 60 may delay the transition to case 1 through the determination buffer and maintain case 3.

In general, the driving road condition does not change quickly, but the road surface condition determined based on the vehicle data may frequently change, and thus, it is necessary to determine the road surface in consideration of a main tendency. In other words, it is necessary to reduce a frequent change in the results determined by the road surface determination unit 80.

To this end, the post-processing unit 70 may apply hysteresis to the result values (continuous values) combined by the combining unit 60.

Then, the road surface determination unit 80 may determine whether the road surface on which the vehicle is running is a high friction road surface or a low friction road surface, using the result value to which the hysteresis is applied.

In other words, the road surface determination unit 80 may determine the road surface as the low friction road surface when the result value to which the hysteresis is applied exceeds a threshold, and may determine the road surface as the high friction road surface unless the result value to which the hysteresis is applied exceeds the threshold.

In the above-described embodiments of the present disclosure, the controller for constructing the inference model and the controller for determining the road surface based on the inference model are provided as separate elements. However, a single controller may also be provided to perform all of the functions.

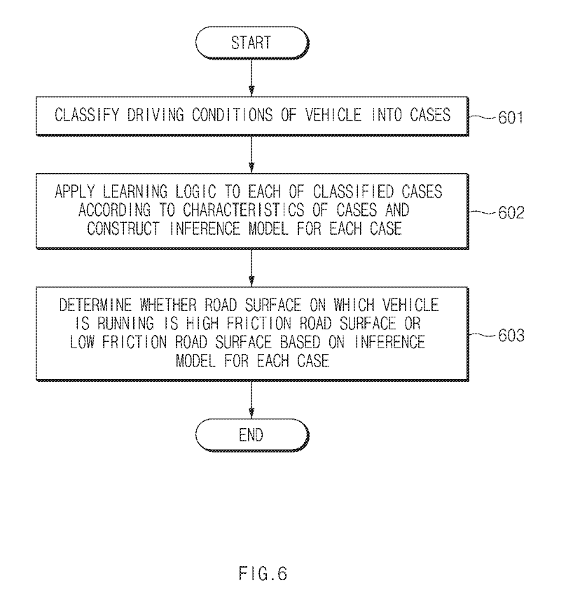

FIG. 6 illustrates a flowchart of a method for determining a road surface based on vehicle data, according to an exemplary embodiment of the present disclosure. It shows a process that is performed by a controller (a processor).

First of all, driving conditions of a vehicle may be classified into a plurality of cases in 601.

Next, a learning logic may be applied to each of the classified cases according to characteristics of the cases, and an inference model for each case may be constructed in 602.

Thereafter, it may be determined whether the road surface on which the vehicle is running is a high friction road surface or a low friction road surface based on the inference model for each case in 603.

Meanwhile, the above-stated method according to the exemplary embodiments of the present disclosure may be written as a computer program. Codes and code segments constituting the program may easily be inferred by a computer programmer skilled in the art. The written program may be stored in a computer-readable recording medium (an information storage medium) and be read and executed by a computer, thereby implementing the method according to the exemplary embodiments of the present disclosure. The recording medium includes all types of computer-readable recording media.

As set forth above, the method for determining a road surface based on vehicle data may be characterized by classifying driving conditions of the vehicle into predetermined cases, applying a learning logic to each case according to characteristics of the cases to construct an inference model for each case, and determining whether a road surface on which the vehicle is running is a high friction road surface or a low friction road surface based on the inference model for each case, thereby determining road surface conditions quickly and accurately regardless of types of roads.

Hereinabove, although the present disclosure has been described with reference to exemplary embodiments and the accompanying drawings, the present disclosure is not limited thereto, but may be variously modified and changed by those skilled in the art to which the present disclosure pertains without departing from the spirit and scope of the present disclosure claimed in the following claims.

What is claimed is:

1. A method for determining, by a controller, a road surface based on vehicle data, the method comprising:
classifying driving conditions of a vehicle into a plurality of cases;
applying a learning logic to each of the classified cases according to characteristics of the cases and constructing an inference model for each case; and
determining whether a road surface on which the vehicle is running is a high friction road surface or a low friction road surface based on the inference model for each case, the vehicle being driven by an operator.

2. The method according to claim 1, wherein constructing the inference model comprises learning the learning logic based on a relationship between an operator's operation of the vehicle and a movement of the vehicle resulting therefrom.

3. The method according to claim 2, wherein constructing the inference model comprises pre-processing data generated by the operator's operation and data related to the movement of the vehicle based on a time window.

4. The method according to claim 3, wherein pre-processing the data comprises calculating a variance of a difference between a front wheel speed and a rear wheel speed, wheel acceleration, a variance of wheel acceleration, and a wheel speed average.

5. The method according to claim 3, wherein pre-processing the data comprises calculating variance of differences between a front wheel speed and a rear wheel speed, wheel acceleration, a variance of wheel acceleration, and a wheel speed average.

6. The method according to claim 1, wherein the cases are classified into a normal driving condition, an acceleration driving condition, and a deceleration driving condition, based on a speed of the vehicle.

7. The method according to claim 6, wherein constructing the inference model comprises using a complex tree as the learning logic when the driving condition of the vehicle is the normal driving condition.

8. The method according to claim 6, wherein constructing the inference model comprises using a support vector machine technique as the learning logic when the driving condition of the vehicle is the acceleration driving condition.

9. The method according to claim 6, wherein constructing of inference model comprises using a neural network as the learning logic when the driving condition of the vehicle is the deceleration driving condition.

10. The method according to claim 1, wherein the determining step comprises:
combining result values obtained using the inference model in order of occurrence of the cases;
applying hysteresis to the combined result value; and
determining whether the road surface on which the vehicle is running is the high friction road surface or the low friction road surface based on the result value to which the hysteresis is applied.

11. The method according to claim 10, wherein the combining step comprises giving a weighting based on a time for which a current case is maintained and delaying a transition time to a next case.

12. The method according to claim 1, wherein the plurality of cases comprise cases based on speed, acceleration and braking.

13. A method for controlling operation of a vehicle, the method comprising:
classifying driving conditions of a vehicle into a plurality of cases;
applying a learning logic to each of the classified cases according to characteristics of the cases and constructing an inference model for each case;
while the vehicle is being driven, determining whether a road surface on which the vehicle is driven is a high friction road surface or a low friction road surface based on the inference model for each case; and
controlling an operation of the vehicle based upon a result of the determining step.

14. The method according to claim 13, wherein the controlling the operation of the vehicle comprises controlling the operation using a user-friendly system.

15. The method according to claim 14, wherein the user-friendly system comprises an anti-lock brake system (ABS), an electronic stability control (ESC) system, a smart cruise control (SCC) system, or an advanced driver assistance system (ADAS).

16. The method according to claim 13, wherein the determining step comprises:
combining result values obtained using the inference model in order of occurrence of the cases;
applying hysteresis to the combined result value; and
determining whether the road surface on which the vehicle is running is the high friction road surface or the low friction road surface based on the result value to which the hysteresis is applied.

17. The method according to claim 16, wherein the combining step comprises giving a weighting based on a time for which a current case is maintained and delaying a transition time to a next case.
